(19) United States
(12) Patent Application Publication
(10) Pub. No.: US 2009/0259377 A1
(43) Pub. Date: Oct. 15, 2009

(54) System and method for shortening brake-activation-reaction time

(76) Inventor: Sergey Anikin, Atherton, CA (US)

Correspondence Address: SERGEY ANIKIN, 87 Walnut Avenue, Atherton, CA, 94027, US

(21) Appl. No.: 12/082,284

(22) Filed: Apr. 11, 2008

(51) Int. Cl. G06F 19/00

(52) U.S. Cl. 701/70

(57) ABSTRACT

A system and method for determining the shortest time needed for a driver to brake a vehicle in case of emergency by attaching tilt sensors to the accelerator and brake pedals or to elements rigidly connected to these pedals, connecting the outputs of these sensors to a computer, registering various moments and time intervals that occur during braking from initiation of release of the accelerator pedal to completion of depressing the brake pedal, and calculating total braking time. The position of the driver's seat is then changed several times in order to determine the position that ensures the shortest brake time. The same procedure can be repeated by determining the shortest brake time when using a specific under-thigh support developed by the inventors. The emergency signal is produced by a randomly illuminating lamp, the light of which is perceived by a photoreceiver and the moment of initiation of which is registered on the computer as the initial point of measurement.

### CROSS-REFERENCES TO RELATED APPLICATIONS

The present patent application relates to pending U.S. patent application Ser. No. 11/5115,192 filed by Sergey Anikin on May 9, 2006 and is titled “Method and System for Shortening Brake-Activation-Reaction Time.”

### FIELD OF THE INVENTION

The present invention relates to ergonomics, in particular to the ergonomics of a vehicle driver as a biomechanical system. More specifically, the invention relates to a method and system for shortening brake-activation reaction time. In particular, the invention concerns a method and system for finding a position for an under-thigh support that provides the shortest brake-activation reaction time. The aforementioned under-thigh support is intended for use by a vehicle driver for supporting and securing the right leg in the position from which the foot of the driver can be turned from the accelerator pedal to the brake pedal in the shortest possible time. The method and system of the invention makes it possible to adjust the position of the under-thigh support for each person in the driver's seat.

### BACKGROUND OF THE INVENTION

Car crashes now claim more than 40,000 lives each year in the United States, a number that has slowly declined from approximately 50,000 per year over the last four decades. Automobile crashes are the leading cause of death among people between the ages of one to 34 years, accounting for 3.4 million nonfatal injuries annually and costing an estimated $200 billion. Rates of automobile fatalities and injuries per driver and per mile driven have decreased substantially because of safer cars and roads, laws that discourage drunk driving, and other measures; however, the absolute toll of automobile crashes remains high.

By the year 2025 33 million people will be 70 years or older in America. This segment of the population will be growing 2.5 times as fast as the total population. These senior citizens will comprise the largest percentage of “slow reaction” accidents. Slowly but surely senior citizens have developed a higher accident ratio than teenagers. Also, by 2025, the total costs for motor vehicle accidents in the United States will exceed 450 billion dollars.

Heretofore many studies have been conducted to improve the ergonomics of a vehicle seat. For example, “Survey of Auto Seat Design Recommendations for Improved Comfort” by M. P. Reed, et al., (University of Michigan, Transportation Research Institute, Ann Arbor), 1994, contains a review of a large body of literature with emphasis on fit parameters related to anthropometric measurements; feel parameters, including pressure distribution and vapor permeability; and support parameters that are defined with respect to seat posture. Particular attention is given to appropriate lumbar support.

Other studies aimed at measuring the reaction time of a driver in dangerous situations can be found in the following publications and Internet material: (1) “Reaction-Time Measurement and Real-Time Data Acquisition for Neuroscientific Experiments in Virtual Environments” by J. Valvoda, et al, Aachen University (http://www.rz.rwth-aachen.de/global/show_document.asp?id=aaaaaaaaaaaxpci); (2) Reaction Time of Drivers to Road Stimuli, Monash University Human Factors Group, Report HFR-12, by T. Triggs and W. Harris (http://www.monash.edu.au/muarc/reports/Other/hfr12.html); and (3) How the Driver Reaction Meter Works (http://www.sibtec.com/driverhowitworks.html).

U.S. Pat. No. 6,170,355 issued in 2001 to W. Fay, III discloses an easily adjustable foot-operated pedal assembly, such as a brake pedal (for use in heavy equipment) that can be placed in multiple positions to accommodate people of differing heights and body shapes.

The necessity for a raised under-thigh support is mentioned in many advertisements for modern cars. For example, “Nissan 350Z GT—MotorBar Road Test” states “a raised bolster in the middle of the seat cushion helps give extra under-thigh support for more precise operation of the pedal.” In the pamphlet, “Follow-Up Test: 2006 Jeep Grand Cherokee SRT8” states “long-haul comfort is commendable, too, with excellent under-thigh support and feeling of the seats wrapping around.”

Investigations show that the total stopping distance of a vehicle comprises four components: human perception time, human reaction time, vehicle reaction time, and vehicle braking capability.

Human perception time is the time it takes a driver to see a hazard and the brain to realize that it is a hazard requiring immediate reaction. This component of stopping distance can be affected by age, fatigue, and concentration levels of alcohol. Human reaction time is the time it takes to move the foot from the accelerator to the brake pedal and then to depress the pedal when the brain realizes danger. Moving from the accelerator to the brake takes approximately 500 ms (according to the University of Iowa).

Heretofore many studies have been conducted in order to determine the response time for pressing the brake pedal. For example, the article “Response Time” by Charles C. Roberts, Jr. (http://www.croberts.com/respon.htm) describes a test apparatus that evaluates this reaction time. As soon as the light turns red on the console, the driver releases the accelerator and applies the brake, and the reaction time is measured. This form of testing is often called “simple reaction time” because it is the result of a single stimulus: the red light. Reaction times are typically on the order of ¾ of a second. However, response times are more complex and can be as high as 3 to 4 seconds because response time consists of perception/decision time plus reaction time. Perception/decision time is the time it takes to view a hazard and to decide what to do about it. Reaction time is the time it takes to perform a particular function once a decision is made. The response time for removing one's hand from a hot skillet is relatively quick and is on the order of approximately a half second. In this example, the natural response to excessive heat bypasses visual sensors, allowing for a quicker response time. Driving an automobile requires a high degree of visual processing, which tends to extend response times. What can be gleaned from the discussions in the article is that response time is a distributed quantity because of variability in people as well as in situations that require a response. The accident-reconstruction community often assumes a maximum 2.5- to 3.0-second response time. This applies to most accidents involving obvious hazards. Other accidents involving less defined or confusing hazards may result in longer response times. Other factors that extend response time are age, time of day, gender, and chemical usage, suggesting that response time is typically characteristic of a particular set of circumstances encountered in an accident.

There are many other studies of response times and their usage, but none of these studies takes into account the effect of finding the most optimal physical position for the driver's leg relative to the accelerator and brake pedal.

When driving a vehicle, the driver's leg that controls the accelerator and brake pedal can be considered a biomechanical system, the model of which is shown in FIG. 1. In the context of the present invention, the part of the leg from the fulcrum point H of the heel on the vehicle floor to the knee joint KN is referred to as “leg L”; the part of the driver's leg from the point H to the point T1 of contact with the accelerator pedal 20 is referred to as “foot FT”; and the part of the driver's leg from the point KN to the pelvic floor joint PF, which is considered the fulcrum point on the vehicle seat 22, is referred to as “thigh TH.”

FIG. 2 is a view of the driver's right leg in the direction of arrow A in FIG. 1. Two planes must be considered for analysis of the movement in which the driver's leg participates. The first plane is plane I-I, which is slightly inclined with respect to vertical plane V-V and passes through the thigh TH and leg L, i.e., the plane that passes through the joints PF, KN, and H′ (where H′ is the heel joint (FIGS. 1 and 2). Plane I-I corresponds to the unrestrained position of the leg during normal driving with the foot FT on the accelerator pedal 20. The second plane is plane II-II, which passes through the same joints when the foot FT is on the brake pedal 24. The position of the leg in plane II-II is shown by broken lines.

Let us consider movements of the driver's leg when one drives a car with an automatic gearbox wherein two pedals, i.e., the accelerator pedal and the brake pedal, are used to control the car. Although in reality these movements are more complicated, in a simplified form they can be considered as the following two modes.

Let us assume that for the initial position of the leg in the first mode, the foot FT is on the accelerator pedal 20. When braking is needed, the driver with relatively short legs first slightly raises the foot FT from the floor F so that the heel disconnects from point H and the leg shifts sidewise to the brake pedal 24. In this movement the entire leg is raised relative to the point PF as a fulcrum. The driver then turns the entire leg relative to the plane I-I to the plane II-II and moves the leg down in order to depress the brake pedal 24.

In the second mode, which is more typical for a driver with relatively long legs, in order to brake from the position on the accelerator pedal 20, the driver merely turns the foot FT relative to the point H.

In reality, the aforementioned movements are more complicated and may comprise a combination of both movements simultaneously. In the context of the present patent application, the movement of the foot from the accelerator pedal to the brake pedal also includes the movement of pushing on the brake pedal until actual initiation of the brakes, i.e., to the moment when the brake lights activate.

It is important to consider the aforementioned movements with regard to the moment of braking. The inventor has been experimentally proven that when a human being accomplishes braking movements on the basis of subconscious reflexes, the aforementioned movements are not at all optional. In other words, there exists a certain unnatural position of the pedal-controlling leg that can provide a more optimal braking condition, i.e., the condition that allows shortening of the braking time and hence of the braking path.

To provide the most optimal position of a driver's right leg in order to shorten the momentum for movement of the feet from the accelerator pedal to the brake pedal and to subsequently depress the brake pedal, the inventor herein has developed a special under-thigh pillow that can be used for supporting and fixing the driver's right leg in the aforementioned optimal position. This under-thigh pillow is the subject of U.S. Pat. No. 7,255,396 issued in 2007 to the same applicant (Sergey Anikin) and is titled “Ergonomic thigh support and method of uniformly distributing pressure on the thigh surface of a seated person”, which is incorporated herein by reference.

Use of the aforementioned under-thigh support is justified only if the aforementioned under-thigh support is installed and fixed in a predetermined position that depends on specific anthropometric data of each individual driver. In other words, the most optimal position of the under-thigh support of the aforementioned patent application will differ for people of various builds.

In order to determine the shortest time needed for a driver to switch the foot from the accelerator pedal to the brake pedal and to push on the brake pedal in an emergency, the inventor herein has developed a system that is disclosed in pending U.S. patent application Ser. No. 11/515,192 filed on May 9, 2006. According to this system, when a danger-imitating signal lamp activates, preferably at random, a first photo-receiver receives the light signal of the lamp and sends it to a signal amplifier, wherefrom the amplified signal is sent to a computer by the time counter. The computer begins to register the length of the light signal. As soon as the driver reacts to the light signal of the signal lamp, he or she moves his or her foot from the accelerator pedal to the brake pedal and pushes on the brake pedal, thus igniting the brake lights. The light of the brake-signal lamp is also activated and sent to the computer. The time interval between the moment of initiation of the first photo-receiver and initiation of the second photo-receiver corresponds to the time of the driver's response to the light signal, which imitates a danger plus the time of transfer from the accelerator pedal to the brake pedal. The above-described test is repeated several times at different positions of the under-thigh support to find the position most optimal for the shortest braking time.

Although such a system, in principle, operates reliably and accomplishes its function properly, one of the disadvantages of the system is that it measures only the integral time from initiation of the danger-imitation light signal to the moment of activation of the brake signal lamp located on the rear side of the vehicle. In other words, there is no information about mental reaction time of the driver from the danger signal to the beginning of transferring one's foot from the gas pedal to the brake pedal, time of transfer of the foot from the gas pedal to the brake pedal, and time of braking from initiation of pressure on the brake pedal to the complete stop of the vehicle. Another disadvantage of the known system is that a part of the system components, i.e., photo-receivers, etc., are located on the outer side of the vehicle. This limits or hinders use of the brake-time control system, e.g., during rain or the like, and requires mounting of the photo-receivers to the vehicle body and dismantling them after the test is completed.

### OBJECTS AND SUMMARY OF THE INVENTION

It is an object of the invention to provide a system for finding the shortest brake-activation time with use of an optimally positioned driver's seat and/or an under-thigh support, wherein the system as a whole is located inside the vehicle in a driver's compartment without any components on the outer side of the vehicle. It is another object to provide the aforementioned system wherein the brake signal lamp is not involved in measuring brake-activation time. It is a further object of the invention to divide the integral brake-activation time into intervals corresponding to mental reaction time of the driver from the danger signal to the beginning of foot transfer from the gas pedal to the brake pedal, time of transfer of the foot from the gas pedal to the brake pedal, and time of braking from initiation of pressure on the brake pedal to complete stop of the vehicle. It is a further object to provide a method for finding the optimal position of a driver's seat and/or an under-thigh support for shortening brake-activation time.

The system of the invention for finding the shortest brake-activation time with the use of an optimally positioned driver's seat and/or under-thigh support consists of a pair of tilt sensors, i.e., sensors that react on deviation of an object from the real vertical or horizontal position, that are attached to a gas (accelerator) pedal and a brake pedal of a vehicle, respectively. Both tilt sensors are connected to a multichannel A/D converter that converts analog voltage signals of the sensors into respective digital signals, which are sent to a computer, e.g., through USB connectors. The system is also provided with a danger-signal lamp and a photo-receiver that reacts on the light signal of the aforementioned lamp. Both the signal lamp and the photo-receiver may be located outside or inside the vehicle. The remaining components of the system are all located inside the vehicle. The computer initiates the danger-imitation light signals at random. All sensors and the danger signal generation lamp are connected to a power supply unit. In order to nullify the initial positions of the tilt sensors, they are adjusted to the horizontal position prior to testing. The sensors may be installed in U-shaped holders that can be fit onto the neck of the pedal rod or any other part that is rigidly connected to the pedal and attached thereto in a position not interfering with normal operation of the accelerator and brake pedals. The principle of operation of the system consists of the following. First, an under-thigh support of the type disclosed, e.g., in U.S. Pat. No. 7,255,396, is placed under the right thigh of a driver sitting in the driver's seat of a vehicle that is controlled by the system. The system components, i.e., sensors, photo-receiver, computer, danger-imitating lamp, etc., are activated when connected to the power supply. In the normal state, the danger-signal imitating lamp is not lit.

Although the test vehicle is stationary, it is assumed that at the beginning of the test, the driver depresses the accelerator pedal with the right foot as though he or she were driving the vehicle under normal conditions. When the danger-signal imitating lamp is lit by a signal randomly generated by the random-number selection function of the computer or from a separately installed conventional random-number generator, the driver is assumed to be confronted with an unexpected obstacle or a dangerous situation that requires emergency braking. The moment at which the danger-imitating signal is activated is registered on the computer.

It is understood that some time is required for the driver to perceive a danger signal and that this danger-signal perception time may depend on factors such as driver fatigue, the driver's vision, the driver's reaction-response time which in turn depends on the driver's age, experience, etc. When the driver reacts to the danger signal, he/she releases the accelerator pedal and transfers the right foot from the accelerator pedal to the brake pedal (we are considering here a situation involving an automatic gearbox, i.e., not a stick-shift-controlled gear box, although the principle of the invention applies to the non-automatic gearbox as well). The computer registers the moment at which the foot transfers from the accelerator to the brake pedal, and the end of this time period is fixed when the tilt sensor connected to the brake pedal begins to change its angular position. The next period of time recorded by the system is that from beginning of braking, e.g., from initiation of tilt-sensor position change to the end of the brake period, i.e., to full stop of the brake pedal.

Upon completion of the first test, the driver marks the position of the under-thigh support, and the test is repeated one or more times with the same measurements but with different positions of the thigh support. The measurement results are compared, and the under-thigh support is fixed in the position that corresponds to the shortest time interval between the light signal and ignition of the brake light. Time signals measured in the same positions of the driver but without the use of the under-thigh support appeared to be longer. This showed that the use of the under-thigh support developed by the application and disclosed in the previous U.S. patent is an efficient means for shortening brake-activation time on the basis of ergonomic factors and characteristics of each specific driver. Moreover, division of integral brake-activation time into separate time intervals allows for control and analysis of various periods of braking time. What is important is that the system and method of the invention apply to optimization of the position not only of the under-thigh support but also to the position of the seat relative to the control elements (pedals, levers, etc.) of the vehicle, as well as for comparing and testing the designs of various seats from the ergonomic point of view.

### BRIEF DESCRIPTION OF THE DRAWINGS

FIG. 1 is a view showing a model in which the driver's leg that controls the accelerator and brake is considered as a biomechanical system.

FIG. 2 is a view of the driver's right leg in the direction of arrow A in FIG. 1.

FIG. 3 is a block diagram of the system of the invention for shortening brake-activation reaction time.

FIG. 4 is a three-dimensional view of the main components of the system in FIG. 3.

FIG. 5 is a three-dimensional view that shows the position of the under-thigh support on the car seat.

FIG. 6 is a view of the tilt sensor and attachment thereof to an element of a vehicle-control pedal.

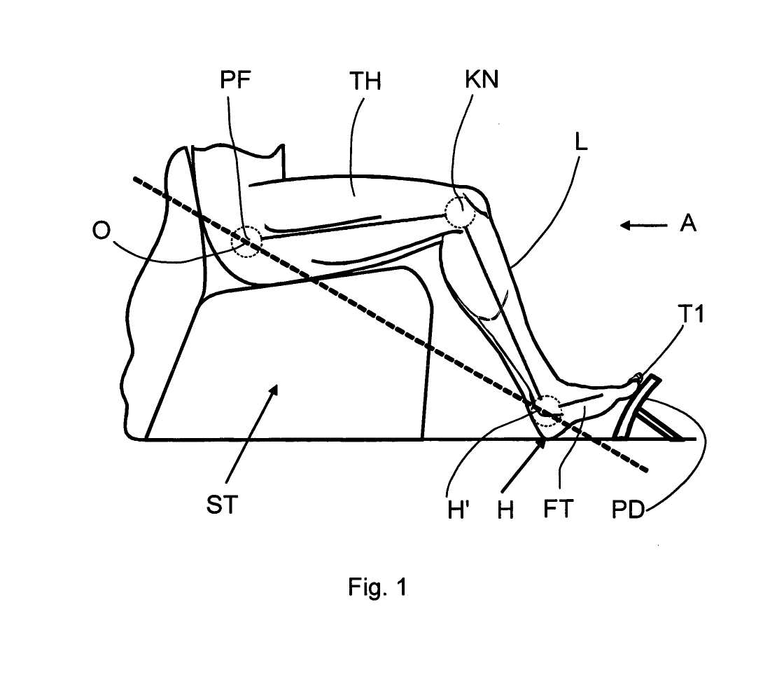

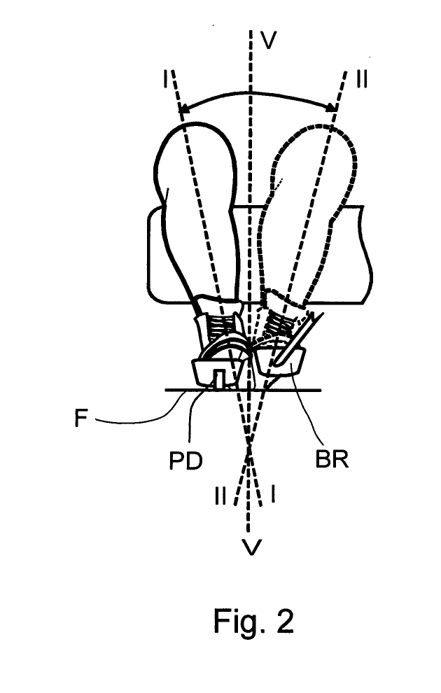

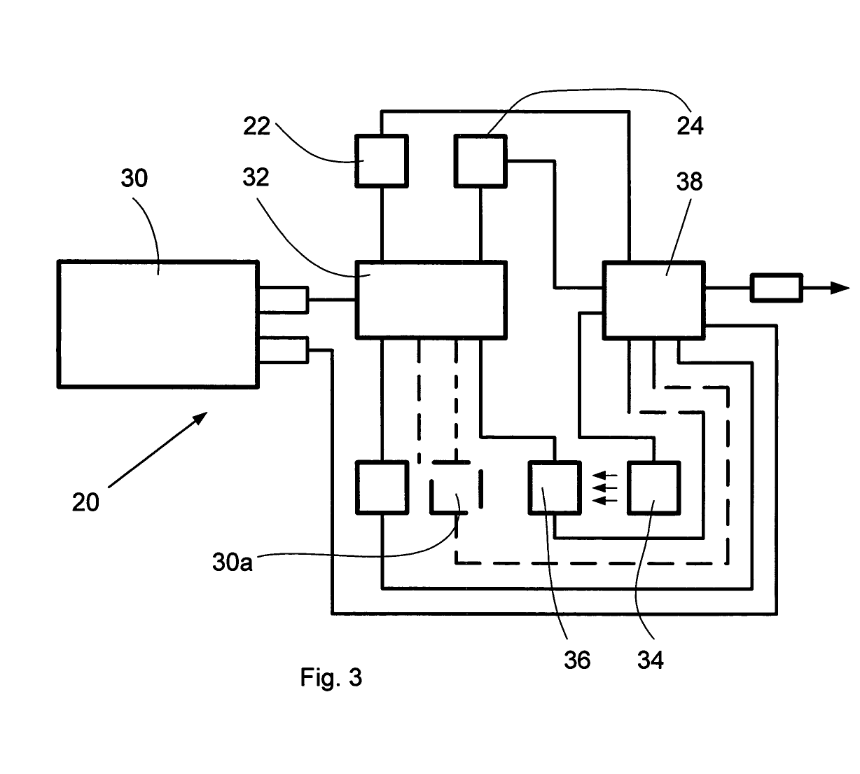

### DETAILED DESCRIPTION OF THE INVENTION

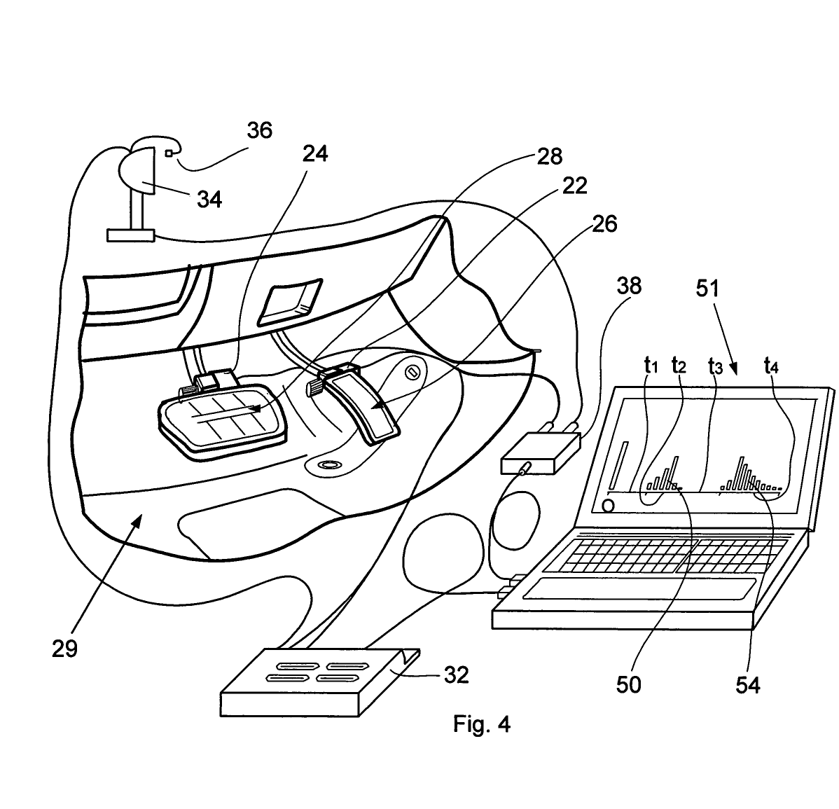

The system of the invention for finding the shortest brake-activation time will now be described in more detail with reference to the accompanying drawings, wherein FIG. 3 is a block diagram of the system of the invention for shortening brake-activation reaction time, and FIG. 4 is a three-dimensional view of the main components of the system of FIG. 3.

The system of the invention for finding the shortest brake-activation time, which as a whole is designated by reference numeral 20, contains a pair of tilt sensors 22 and 24, i.e., sensors that react on deviation of an object from the real vertical or horizontal position and constitute main components of the system 20. Such sensors are described, e.g., by D. Pheifer and W. Powell in “The Electrolytic Tilt Sensor” (http://www.sensorsmag.com/articles/0500/120/main.shtml). Electrolytic tilt sensors are capable of producing extremely accurate pitch and roll measurements in a variety of applications. They provide excellent repeatability, stability, and accuracy when operating at low frequencies, and are available in a variety of packages with varying tilt range and resolution. These rugged, passive devices can be used in environments of extreme temperature, humidity, and shock.

The sensor is filled with an electroconductive liquid. As the sensor tilts, the surface of the fluid remains level due to gravity. Conductivity between the two electrodes of the sensor is proportional to the length of the electrode immersed in fluid. Electrically, the sensor is similar to a potentiometer, with resistance changing in proportion to tilt angle.

To prevent electrolysis, alternating current must be used to excite the sensor. The required frequency and symmetry of the AC waveform depend on the chemistry of the fluid and composition of the electrodes. The frequency must be high enough so that the process described above is reversible. For some electrolytes this frequency can be from 1000 Hz to 4000 Hz.

As shown in FIG. 4, the sensor 22 is attached to a gas (accelerator) pedal 26, and the sensor 24 is attached to the brake pedal 28 of a vehicle 29, respectively. Both tilt sensors 22 and 24 are connected to a multichannel A/D converter 32 that converts analog voltage signals of the sensors 22 and 24 into respective digital signals, which are sent to a computer, e.g., laptop computer 30, e.g., through USB connectors 32. An example of the multichannel A/D converter 32 is one produced by Measurement Computing Company and disclosed in: http://www.measurementcomputing.com/cbicatalog/cbiproduct new.asp?dept id=413&pf id=1666&mscssid=VWNLHK1EVLMR8PQS18BF4B2P1MN50866. The device has simultaneously sampled 16-bit analog inputs with sample rates up to 50 kS/s per channel with continuous module throughputs of 150 kS/s and 32-kilosample bursts up to 200 kS/s. The USB-1616FS also provides one 32-bit counter and 8 bits of digital I/O.

The USB-1616FS has an all-aluminum chassis that ensures a device rugged enough for any application. The combination of the USB-1616FS and Measurement Computing's DAQ software suite provides a complete and easy data acquisition solution.

The system is also provided with a danger-imitation-signal means, e.g., signal lamp 34 and a danger-signal perception sensor, e.g., a photoreceiver 36 that reacts on the light signal of the aforementioned lamp 36 (FIG. 3). Both the signal lamp 34 and the photoreceiver 36 can be located outside or inside the vehicle 29. All remaining components of the system are located inside the vehicle. The danger-imitation light signals generated by the lamp 34 are randomly initiated from the computer 30. Sensors 22 and 24, the photoreceiver 36, and the danger-signal-generation lamp 34 are connected to a power supply unit 38. An example of a power supply unit suitable for the system of the invention is AC/DC power supply unit of Wall Industries, Inc, as shown in: (http://www.wallindustries.com/productcart/pc/viewCat P2.asp?idCategory=84).

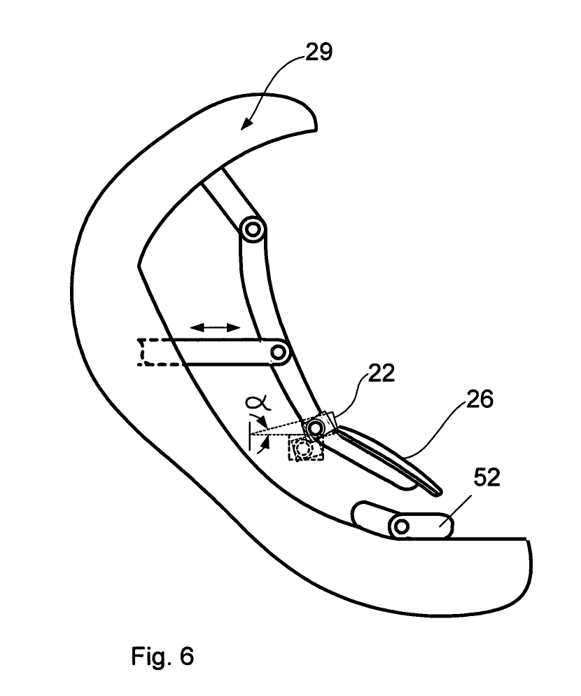

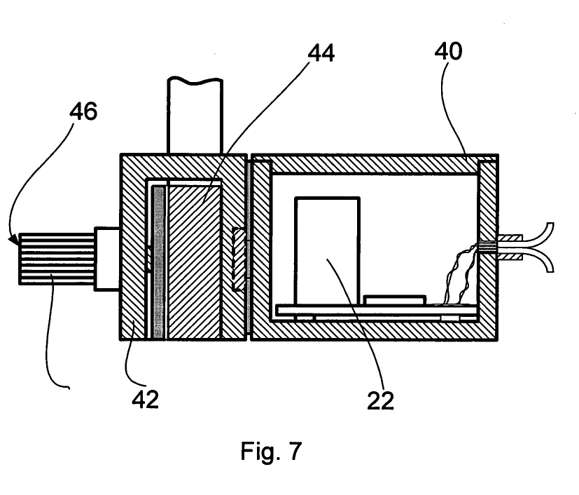

In order to nullify the initial positions of the tilt sensors 22 and 24, they are adjusted to the horizontal position prior to testing. As shown in FIG. 6, each sensor, e.g., sensor 22, is installed in an enclosed casing 40, which is attached to a U-shape holder 42 that can be fit onto the rod 44 of the pedal 22 (FIG. 4) or any other part rigidly connected to the pedal and attached thereto in a position not interfering with normal operation of the accelerator or brake, respectively (not shown). In the construction shown in FIG. 6, the holder 42 has a screw 46 with a knurled head 48 to secure the retainer to the pedal rod 44. In order to allow adjustment of the tilt sensor in the horizontal position which is needed for setting the sensor 22 to the initial position for measurement, the casing 40 has friction engagement with the holder, can be turned relative to the holder 42, and remains in the adjusted position due to aforementioned friction engagement. It is understood that the sensor 24 may have a similar mechanism of attachment to the brake pedal 28.

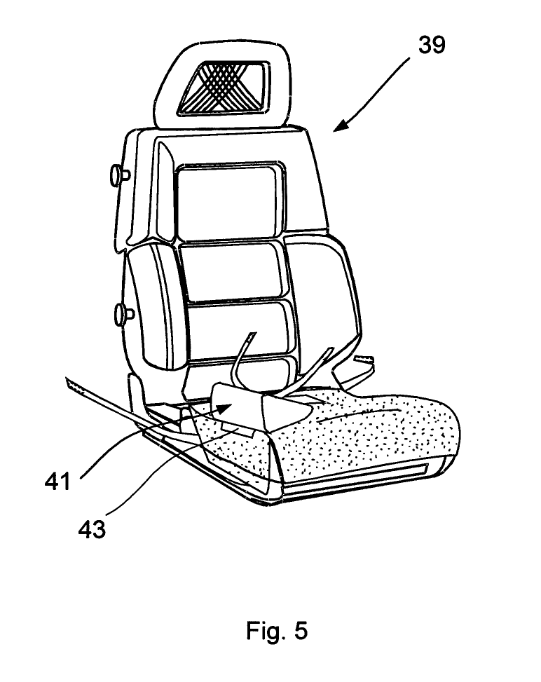

The principle of operation of the system consists of the following. When an under-thigh support (not shown) is used, first this under-thigh support, e.g., of the type disclosed, e.g., in U.S. Pat. No. 7,255,396, is placed under the right thigh of a driver sitting in the driver's seat of a vehicle 30 controlled by the system 20 (FIGS. 3 and 4). The system components, i.e., sensors 22 and 24, the photoreceiver 36, the computer 30, the danger-imitating lamp, 34, etc., are energized by connection to the power supply unit 38. In the normal state, the danger-signal-imitating lamp 34 is not lit. Position of the under-thigh support on the car seat is shown in FIG. 5, wherein reference numeral 39 designates the car seat, reference numeral 41 designates the under-thigh support, and reference numeral 43 designates means for fixing the under thigh support to the car seat 39.

Although the test vehicle is stationary, it is assumed that at the beginning of the test, the driver depresses the accelerator pedal 26 with the right foot as though he or she were driving the vehicle 30 under normal conditions. When the danger-signal imitating lamp 34 is lit by a signal randomly generated by the random-number selection function of the computer 30 or from a separately installed conventional random-number generator 30a, which is conventionally shown in the drawing by dash-and-dot lines, it is assumed that the driver is confronting an unexpected obstacle or a dangerous situation on the road that requires emergency braking. The moment of generation of the danger-imitating signal is registered on the computer 30.

It is understood that some time is required for the driver to perceive a danger signal and that this danger-signal perception time may depend on factors such as driver fatigue, vision of the driver, reaction-response time of the driver which in turn depends on the driver's age, experience, etc. When the driver reacts to a danger signal, he/she releases the accelerator pedal 26 and transfers the right foot from the accelerator pedal 26 to the brake pedal 28 (we are considering here an automatic gearbox, i.e., not a stick-shift-controlled gear box, although the principle of the invention is applicable to the non-automatic gearbox as well). The computer 30 registers the moment at which the foot transfers from the accelerator pedal 26 to the brake pedal 28, and the end of this time period is fixed when the tilt sensor 24 connected to the brake pedal 28 begins to change its angular position. The next time period recorded by the system 20 is the time from the beginning of braking, e.g., from initiation of change in the position of the tilt sensor 24 to the end of the brake period, i.e., to the full stop of the brake pedal 28.

Upon completion of the first test, the driver marks the position of the under-thigh support 41, and the test is repeated one or more times with the same measurements but with different positions of the thigh support 41. The results of measurements are compared, and the under-thigh support 41 is fixed in the position that corresponds to the shortest time interval between the light signal and ignition of the brake light. Time signals measured in the same positions of the driver but without use of the under-thigh support appeared to be longer. This showed that the use of the under-thigh support 41 developed by the application and disclosed in the previous U.S. patent is an efficient means for shortening brake-activation time on the basis of ergonomic factors and characteristics of each specific driver. Moreover, division of integral brake-activation time into separate time intervals allows for control and analysis of various periods of braking time. What is important is that the system and method of the invention makes it possible to optimize the position not only of the under-thigh support 41 but also of the car seat 39 relative to the control elements (pedals 26 and 28, lever 44 (FIG. 4), etc.) of the vehicle 29. It is also becomes possible to compare and test the designs of various seats 39 from an ergonomic point of view.

An example of the records by device 20 is illustrated on the screen of the laptop 30 shown in FIG. 4. The bar graph 50 seen on the left side of the screen 52 shows bars that gradually increase from left to right. The abscissa axis corresponds to time, and the ordinate axis corresponds to the intensity of the voltage signal obtained from the sensor 22 in proportion to the angle of inclination of the tilt sensor 22 and converted by the multichannel A/D converter into a digital signal, as shown on the bar graph 50. As mentioned above, at the beginning of the test, the accelerator pedal 26 is pressed at the horizontal position of the tilt sensor, which corresponds to 0 or reference point on the graph 50. This position may be determined by a stopper 52 under the pedal 26. When the driver sees the danger signal in the form of a flashing light from the lamp 34, a certain time t₁ passes to the moment when the driver reacts to this signal and begins to release the accelerator pedal 26. The growing value of the bars on the bar graph 50 corresponds to an increase in the inclination angle of the tilt sensor 26.

After the accelerator pedal is completely released, which corresponds to the end of period t₂, the driver transfers the right foot from the accelerator pedal 26 to the brake pedal 28. This time interval is t₃. The bar graph 54 with time t₄ corresponds to depression of the brake pedal 28. The braking period is stopped at the end of time interval t₄, which corresponds to completion of the brake-pedal stroke.

Thus, it can be seen that the method and system 20 of the invention make it possible to divide the total braking time T into the aforementioned separate specific periods t₁, t₂, t₃, and t₄, which in addition to finding the shortest total braking time T allows evaluation of factors such as effect of driver fatigue, reactive capacity of the driver to emergency situations, the most ergonomic position of the leg and foot, etc. Furthermore, the method and system 20 of the invention make it possible to analyze the effect of the position of the car seat and/or a thigh support on the aforementioned time periods T, t₁, t₂, t₃, and t₄.

It is shown that the invention provides a system and method for finding the shortest brake-activation time with the use of an optimally positioned driver's seat or/and under-thigh support, wherein the system as a whole is located inside the vehicle in the driver's compartment without any components on the outer side of the vehicle. In the system of the invention, the brake-signal lamp is not involved in measurement of brake-activation time. Integral brake-activation time is divided into intervals corresponding to mental reaction times of the driver from the danger signal to the moment at which the foot transfers from the gas pedal to the brake pedal, the moment at which the foot transfers from the gas pedal to the brake pedal, and the braking time from initiation of pressure on the brake pedal to the complete stop of the vehicle.

Although the invention has been shown and described with reference to specific embodiments, it is understood that these embodiments should not be construed as limiting the areas of application of the invention and that any changes and modifications are possible provided that these changes and modifications do not depart from the scope of the attached patent claims. For example, the danger-imitation signal may be in the form of a sound signal, the combination of a visible and a sound signal in the form of an object that unexpectedly appears in front of the windshield, etc. It is not necessary to switch off the danger-signal lamp, and this lamp may remain ignited to the end of the test cycle. The signals can be wirelessly transferred from the sensors to the computer located outside the vehicle. The principle of the invention also applies to vehicles in which the driver sits on the left.

1. A system for shortening brake-activation-reaction time for a driver of a vehicle wherein the accelerator pedal and the brake pedal are controlled by the foot of the driver who sits in the driver's seat, said system comprising:
danger-imitation means that generates a danger-imitation signal perceived by said driver who sits in the driver's seat;
a danger-signal perception sensor;
a first sensor that is attached to the accelerator pedal and is sensitive to movement of the accelerator pedal;
a second sensor that is attached to the brake pedal and is sensitive to movement of the brake pedal;
a multichannel A/D converter connected to the first sensor and to the second sensor for converting voltage signals of the aforementioned first sensor, second sensor, and danger-signal-perception sensor into digital signals; and
a computer connected to the multichannel A/D converter for receiving and displaying said digital signals and to the danger-imitating means for randomly activating the danger-imitation means.

2. The system of claim 1, further comprising a power-supply unit that is connected at least to the first sensor, second sensor, danger-imitation means, and danger-signal-perception sensor.

3. The system of claim 1, wherein the first sensor and the second sensor are tilt sensors that react on an angle of inclination of the aforementioned first sensor and second sensor.

4. The system of claim 3, wherein the first sensor and the second sensor is provided with a holder attachable to the respective pedal and has means for changing an angular position with respect to the aforementioned holder and for fixation in said angular position.

5. The system of claim 4, wherein said means for changing an angular position with respect to the aforementioned holder and for fixation in said angular position is friction engagement between the holder and the sensor.

6. The system of claim 1, wherein the entire system is located inside the vehicle.

7. The system of claim 6, wherein the computer is a laptop-type computer.

8. The system of claim 3, wherein the entire system is located inside the vehicle.

9. The system of claim 8, wherein the computer is a laptop-type computer.

10. The system of claim 4, wherein the entire system is located inside the vehicle.

11. The system of claim 10, wherein the computer is a laptop-type computer.

12. A method for shortening brake-activation-reaction time for a driver of a vehicle wherein the accelerator pedal and the brake pedal are controlled by the foot of the driver who sits in the driver's seat, said method comprising the steps of:
(a) providing a system comprising a danger-imitation means that generates a danger-imitation signal perceived by said driver who sits in the driver's seat; a danger-signal-perception sensor; a first sensor that is attached to the accelerator pedal and is sensitive to movement of the accelerator pedal; a second sensor that is attached to the brake pedal and is sensitive to movement of the brake pedal; a multichannel A/D converter connected to the first sensor and second sensor for converting voltage signals of the aforementioned first sensor, second sensor, and danger-signal-perception sensor into digital signals; and a computer connected to the multichannel A/D converter for receiving and displaying said digital signals and to the danger-imitating means for randomly activating the danger-imitation means, the driver holding his/her foot on the accelerator pedal in a position imitating normal driving conditions;
(b) randomly imitating a danger-imitation signal from the danger-imitation means and registering on the computer the moment of initiation of the danger imitation signal;
(c) registering on the computer the moment when the brake pedal is completely depressed;
(d) calculating the total time of braking from the moment of initiation of the danger-imitation signal to the moment when the brake pedal is completely depressed;
(e) changing the position of the driver's seat;
(f) repeating steps (b) to (d) at least one more time;
(g) comparing the total time obtained in step (d) with the total time obtained in step (f); and
(h) locking the driver's seat in a position that corresponds to the shortest total time of braking.

13. The method of claim 12, further comprising the following steps between steps (b) and (c):
(c-1) registering on the computer the moment at which the driver begins to release the foot from the accelerator pedal in response to the danger-imitation signal;
(c-2) registering on the computer the moment at which the accelerator pedal is released and transfer of the foot from the accelerator pedal to the brake pedal begins; and
(c-3) registering on the computer the moment at which the driver's foot begins to depress the brake pedal.

14. The method of claim 13, further comprising the step of evaluating reaction time of the driver in an emergency situation that requires immediate braking by analyzing the time intervals between the aforementioned moments registered on the computer.

15. The method of claim 12, further comprising the step of providing an under-thigh support, placing the under-thigh support under the driver's right thigh in the first position; carrying out steps (b), (c), and (d); changing at least once the position of the under-thigh support by installing the under-thigh support into the second position; repeating steps (b), (c), and (d); and securing the under-thigh support to the driver's seat in a position that corresponds to the shortest total time of braking.

16. The method of claim 15, further comprising the following steps between steps (b) and (c):
(c-1) registering on the computer the moment at which the driver begins to release the foot from the accelerator pedal in response to the danger-imitation signal;
(c-2) registering on the computer the moment at which the accelerator pedal is released and transfer of the foot from the accelerator pedal to the brake pedal begins; and
(c-3) registering on the computer the moment at which the driver's foot begins to depress the brake pedal.

17. The method of claim 15, wherein the under-thigh support is one comprising means for preventing sliding of the under-thigh support on the surface of the driver's seat and having a support surface that is raised above the surface of driver's seat and is tapered in the direction from the right thigh of the driver toward the center of the driver's seat for supporting the driver's thigh in a position that provides the shortest reaction time for movement of the driver's leg from the accelerator pedal to the brake pedal and for activation of the brake.

18. The method of claim 17, wherein the under-thigh support is one claimed in U.S. Pat. No. 7,255,396.

19. The method of claim 12, wherein the first sensor and the second sensor are tilt sensors.

20. The method of claim 15, wherein the first sensor and the second sensor are tilt sensors.
